(19) United States
(12) Patent Application Publication
(10) Pub. No.: US 2003/0231093 A1
(43) Pub. Date: Dec. 18, 2003

(54) Microelectronic inductor structure with annular magnetic shielding layer

(75) Inventors: Heng-Ming Hsu, Hsin-Chu (TW); Shyh-Chyi Wong, Hsin-Chu (TW); Jiong-Guang Su, Hsin Chu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/171,212

(22) Filed: Jun. 13, 2002

(51) Int. Cl. H01F 5/00

(52) U.S. Cl. 336/200

(57) ABSTRACT

Within both a method for fabricating a microelectronic inductor structure, and the microelectronic inductor structure fabricated employing the method, there is formed over a substrate a spirally patterned conductor layer. Within both the method and the microelectronic inductor structure there is also formed over the substrate and annularly surrounding the spirally patterned conductor layer an annular magnetic shielding layer.

### BACKGROUND OF THE INVENTION

1. Field of the Invention

The present invention relates generally to inductor structures fabricated within microelectronic fabrications. More particularly, the present invention relates to planar spiral inductor structures fabricated within microelectronic fabrications.

2. Description of the Related Art

Microelectronic fabrications are fabricated from microelectronic substrates over which are formed patterned microelectronic conductor layers which are separated by microelectronic dielectric layers.

As microelectronic fabrication integration levels and functionality levels have increased, it has become common in the art of microelectronic fabrication to employ, in addition to generally conventional microelectronic device structures such as but not limited to transistor structures, resistor structures, diode structures and capacitor structures when fabricating microelectronic fabrications, less conventional microelectronic device structures such as inductor structures when fabricating microelectronic fabrications. In particular, within microelectronic fabrications which are intended to be employed within high frequency microelectronic fabrication applications, such as mobile communications high frequency microelectronic fabrication applications, it is often common to employ microelectronic inductor structures within those microelectronic fabrications.

While microelectronic inductor structures are thus desirable and often essential within the art of microelectronic fabrication, microelectronic inductor structures are nonetheless not entirely without problems in the art of microelectronic fabrication. In that regard, it is typically desirable in the art of microelectronic fabrication, but nonetheless not always readily achievable in the art of microelectronic fabrication, to fabricate microelectronic fabrications having fabricated therein microelectronic inductor structures with enhanced performance.

It is thus towards the goal of fabricating within microelectronic fabrications microelectronic inductor structures with enhanced performance that the present invention is directed.

Various microelectronic inductor structures having desirable properties have been disclosed in the art of microelectronic fabrication.

Included among the microelectronic inductor structures, but not limiting among the microelectronic inductor structures, are microelectronic inductor structures disclosed within: (1) Shiga, in U.S. Pat. No. 5,396,101 (a planar spiral microelectronic inductor structure having formed within its center a core layer); (2) Staudinger et al., in U.S. Pat. No. 5,481,131 (a planar spiral microelectronic inductor structure having formed almost completely annularly at its periphery a planar capacitor); and (3) Burgharz et al., in U.S. Pat. No. 6,114,937 (another planar spiral microelectronic inductor structure having formed within its center a core layer).

The teachings of each of the foregoing disclosures are incorporated herein fully by reference.

Desirable in the art of microelectronic fabrication are additional methods and materials which may be employed for fabricating within microelectronic fabrications microelectronic inductor structures with enhanced performance.

It is towards the foregoing object that the present invention is directed.

### SUMMARY OF THE INVENTION

A first object of the present invention is to provide a method for fabricating a microelectronic inductor structure within a microelectronic fabrication, as well as the microelectronic inductor structure fabricated within the microelectronic fabrication while employing the method.

A second object of the present invention is to provide a method and a microelectronic inductor structure in accord with the first object of the present invention, wherein the microelectronic inductor structure is fabricated with enhanced performance.

A third object of the present invention is to provide a method in accord with the first object of the present invention and the second object of the present invention, where the method is readily commercially implemented.

In accord with the objects of the present invention, there is provided by the present invention a method for fabricating a microelectronic inductor structure within a microelectronic fabrication, as well as a microelectronic inductor structure which may be fabricated within the microelectronic fabrication while employing the method.

To practice the method of the present invention, there is first provided a substrate. There is then formed over the substrate a spirally patterned conductor layer which forms a planar spiral inductor. Finally, there is also formed over the substrate such as to annularly surround the spirally patterned conductor layer an annular magnetic shielding layer.

The method of the present invention contemplates a microelectronic inductor structure fabricated in accord with the method of the present invention.

There is provided by the present invention a method for fabricating a microelectronic inductor structure within a microelectronic fabrication, as well as the microelectronic inductor structure fabricated within the microelectronic fabrication while employing the method, wherein the microelectronic inductor structure is fabricated with enhanced performance.

The present invention realizes the foregoing object by employing when fabricating a microelectronic inductor structure within a microelectronic fabrication in accord with the present invention an annular magnetic shielding layer annularly surrounding a spirally patterned conductor layer which comprises a planar spiral inductor within the microelectronic inductor structure.

The method of the present invention is readily commercially implemented. As will become clear within the context of the description of the preferred embodiment which follows, a microelectronic inductor structure fabricated in accord with the present invention may be fabricated employing methods and materials as are otherwise generally conventional in the art of microelectronic fabrication, but with specific structural and materials limitations to provide a microelectronic inductor structure in accord with the present invention. Since it is thus largely structural features and materials features of a microelectronic inductor structure which provides at least in part the present invention, rather than the existence of methods and materials which provides the present invention, the method of the present invention is readily commercially implemented.

### BRIEF DESCRIPTION OF THE DRAWINGS

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 and FIG. 2 show a pair of schematic plan view diagrams illustrating the results of progressive stages in forming a microelectronic inductor structure in accord with a preferred embodiment of the present invention.

FIG. 3 shows a schematic cross-sectional diagram of a microelectronic inductor structure corresponding with the microelectronic inductor structure whose schematic plan view diagram is illustrated in FIG. 2.

### DESCRIPTION OF THE PREFERRED EMBODIMENTS

There is provided by the present invention a method for fabricating a microelectronic inductor structure within a microelectronic fabrication, as well as the microelectronic inductor structure fabricated within the microelectronic fabrication while employing the method, wherein the microelectronic inductor structure is fabricated with enhanced performance.

The present invention realizes the foregoing object by employing when fabricating a microelectronic inductor structure within a microelectronic fabrication in accord with the present invention an annular magnetic shielding layer annularly surrounding a spirally patterned conductor layer which comprises a planar spiral inductor within the microelectronic inductor structure.

A microelectronic inductor structure fabricated in accord with the present invention provides particular value when fabricating an integrated circuit microelectronic fabrication which may be employed for higher frequency microelectronic fabrication applications, such as but not limited to wireless communications higher frequency microelectronic fabrication applications. However, a microelectronic inductor structure in accord with the present invention may be fabricated within a microelectronic fabrication selected from the group including but not limited to integrated circuit microelectronic fabrications, ceramic substrate microelectronic fabrications, solar cell optoelectronic microelectronic fabrications, sensor image array optoelectronic microelectronic fabrications and display image array optoelectronic microelectronic fabrications. Similarly, a microelectronic inductor structure in accord with the present invention may be employed within microelectronic fabrication applications including but not limited to higher frequency (i.e., greater than about 100 MHZ) microelectronic fabrication applications, mid range frequency (i.e., from about 100 MHZ to about 1000 MHZ) microelectronic fabrication applications and lower frequency (i.e., less than about 100 MHZ) microelectronic fabrication applications.

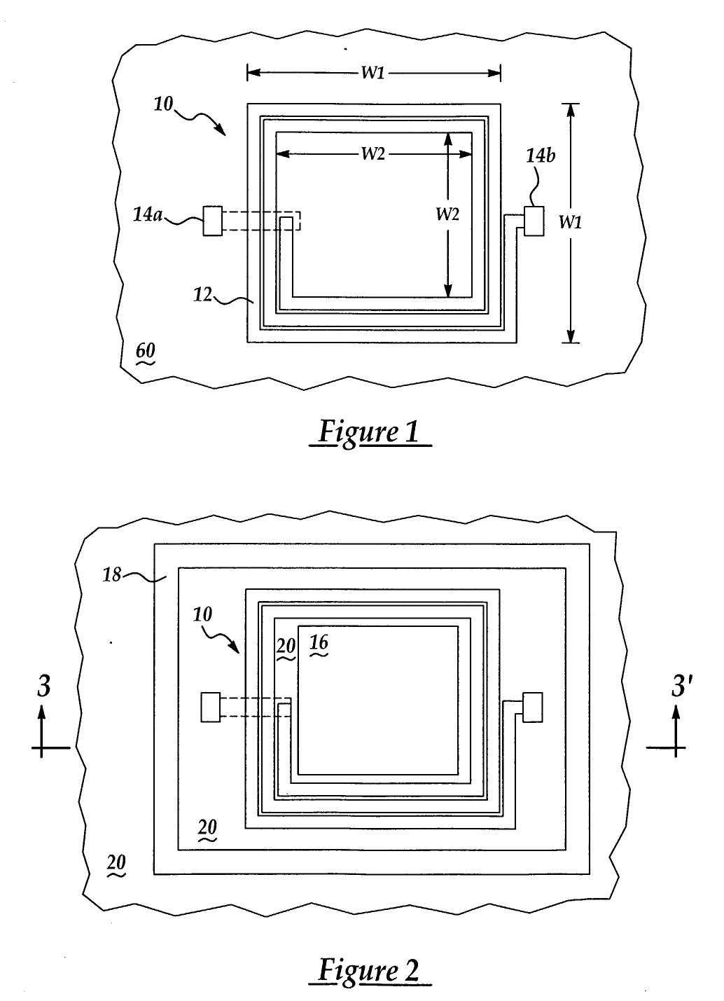

Referring now to FIG. 1 and FIG. 2, there is shown a pair of schematic plan view diagrams illustrating the results of progressive stages in fabricating a microelectronic inductor structure in accord with a preferred embodiment of the present invention.

Shown in FIG. 1 is a schematic plan view diagram of the microelectronic inductor structure at an early stage in its fabrication in accord with the preferred embodiment of the present invention.

Shown in FIG. 1 is a dielectric substrate layer 60 having formed thereupon a spirally patterned conductor layer 12 which terminates in: (1) a first bond pad region 14a integral to the spirally patterned conductor layer while employing an underpass to an interior section of the spirally patterned conductor layer 12; and (2) a second bond pad region 14b integral to an exterior section of the spirally patterned conductor layer 12. Within the schematic plan view diagram of FIG. 1, the spirally patterned conductor layer 12 forms a planar spiral inductor 10 in accord with the present invention.

As is illustrated within the schematic plan view diagram of FIG. 1, the spirally patterned conductor layer 12 is formed of a bi-directional outer spiral width W1 of from about 30 μm to about 500 μm, while similarly having a bi-directional inner spiral width W2 of from about 0 μm to about 30 μm which forms a central cavity defined by the spirally patterned conductor layer 12.

Although not specifically illustrated within the schematic plan view diagram of FIG. 1, at portions of the spirally patterned conductor layer 12 other than those within the first bond pad region 14a and the second bond pad region 14b of the spirally patterned conductor layer 12, the spirally patterned conductor layer 12 is formed with a linewidth of from about 3 μm to about 30 μm. Similarly, at portions of the spirally patterned conductor layer 12 other than those within the first bond pad region 14a and the second bond pad region 14b of the spirally patterned conductor layer 12, adjacent traces of the spirally patterned conductor layer 12 are separated by a separation width of from about 0.5 μm to about 15 μm. Finally, although the schematic plan view diagram of FIG. 1 illustrates the planar spiral inductor 10 of the present invention as being formed employing two and one half full turns in a nominally rectangular geometry, planar spiral inductor structures in accord with the present invention may be formed employing geometries including but not limited to triangular geometries, square geometries, rectangular geometries, higher order polygonal geometries, elliptical geometries and circular geometries having full turns ranging from about 1 to about 20.

Referring now to FIG. 2, there is shown a schematic plan view diagram illustrating the results of further processing of the microelectronic inductor structure whose schematic plan view diagram is illustrated in FIG. 1.

Shown in FIG. 2 is a schematic plan view diagram of a microelectronic inductor structure otherwise equivalent to the microelectronic inductor structure whose schematic plan view diagram is illustrated in FIG. 1, but wherein, in a first instance, there is formed and planarized upon the planar spiral inductor 10 a patterned planarized intra coil dielectric layer 20. Similarly, there is also shown within the schematic plan view diagram of FIG. 2: (1) formed within the patterned planarized intra-coil dielectric layer 20 and within the central cavity defined within the center of the spirally patterned conductor layer 12 a magnetic core layer 16; and (2) formed within the patterned planarized intra-coil dielectric layer 20 and completely annularly surrounding the spirally patterned conductor layer 12 an annular magnetic shielding layer 18.

Within the present invention and the preferred embodiments of the present invention, the magnetic core layer 16 provides an enhanced Q factor for a microelectronic inductor structure fabricated in accord with the present invention, while the annular magnetic shielding layer 18 provides for enhanced annular magnetic shielding of the planar spiral inductor 10.

As is understood by a person skilled in the art, a Q factor of a microelectronic inductor structure is in general described in terms of a ratio of energy storage capacity within the microelectronic inductor structure with respect to power dissipation within the microelectronic inductor structure. Additional description of Q factor is disclosed within the related art references cited within the Description of the Related Art.

Within the present invention, the magnetic core layer 16 may be employed independently of the annular magnetic shielding layer 18 when fabricating a microelectronic inductor structure in accord with the present invention. Similarly, while the schematic plan view diagrams of FIG. 1 and FIG. 2 illustrate a microelectronic inductor structure in accord with the present invention formed while first fabricating the spirally patterned conductor layer 12 and then the magnetic core layer 16 in conjunction with the annular magnetic shielding layer 18, alternative and reverse ordering of fabrication of the foregoing layers is also within the context of the present invention.

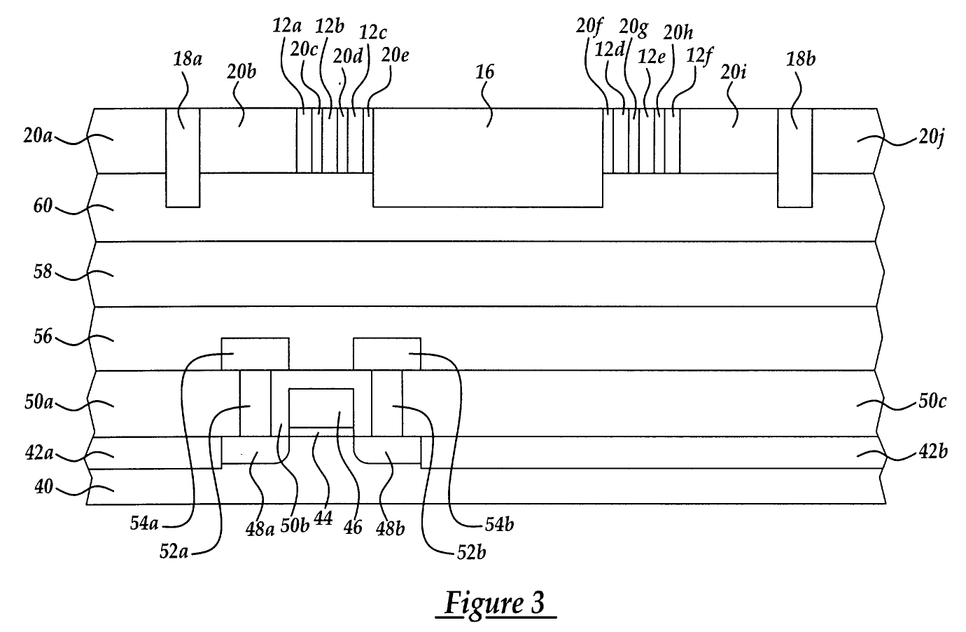

Referring now to FIG. 3, there is shown a schematic cross-sectional diagram of a microelectronic inductor structure corresponding with the microelectronic inductor structure whose schematic plan view diagram is illustrated in FIG. 2.

Shown within the schematic cross-sectional diagram of FIG. 3 is a semiconductor substrate 40 having formed therein a pair of isolation regions 42a and 42b which define an active region of the semiconductor substrate 40. Similarly, there is also shown within the schematic cross-sectional diagram of FIG. 3, and formed within and upon the active region of the semiconductor substrate 40 a series of structures which comprises a field effect transistor (FET) device. The series of structures which comprises the field effect transistor (FET) device includes: (1) a gate dielectric layer 44 formed upon the active region of the semiconductor substrate 40, the gate dielectric layer having formed and aligned thereupon; (2) a gate electrode 46, where the gate dielectric layer 44 and the gate electrode 46 further define; (3) a pair of source/drain regions 48a and 48b formed within the active region of the semiconductor substrate 40 at areas not covered by the gate dielectric layer 44 and the gate electrode 46. Each of the foregoing layers and structures may be formed employing methods, materials and dimensions as are conventional in the art of semiconductor integrated circuit microelectronic fabrication.

Similarly, there is also shown within the schematic cross-sectional diagram of FIG. 3: (1) a series of patterned pre-metal dielectric (PMD) layers 50a, 50b and 50c formed upon the semiconductor substrate 40 having formed therein the pair of isolation regions 42a and 42b which define the active region of the semiconductor substrate in turn having formed therein the field effect transistor (FET) device, where the series of patterned pre-metal dielectric layers 50a, 50b and 50c define a pair of vias which leave exposed the pair of source/drain regions 48a and 48b; (2) a pair of conductor contact studs 52a and 52b formed into the pair of vias, the pair of conductor contact studs 52a and 52b having formed connected thereto a pair of patterned first conductor layers 54a and 54b; and (3) a series inter-metal dielectric (IMD) layers 56, 58 and 60 formed further passivating the pair of patterned first conductor layers 54a and 54b and the series of patterned pre-metal dielectric (PMD) layers 50a, 50b and 50c.

Similarly with the semiconductor substrate 40 having formed therein and thereupon the field effect transistor (FET) device as illustrated within the schematic cross-sectional diagram of FIG. 3, the foregoing conductor layers and dielectric layers may similarly also be formed employing methods, materials and dimensions as are conventional in the art of semiconductor integrated circuit microelectronic fabrication.

Finally, there is shown within the schematic cross-sectional diagram of FIG. 3 a pair of annular magnetic shielding layers 18a and 18b (representative of the annular magnetic shielding layer 18 as illustrated within the schematic plan view diagram of FIG. 2) having contained within their separation distance a series of spirally patterned conductor layers 12a, 12b, 12c, 12d, 12e and 12f (representative of the spirally patterned conductor layer 12 as illustrated within the schematic plan view diagram of FIG. 2), further having contained within their separation distance the magnetic core layer 16 (as is also illustrated within the schematic plan view diagram of FIG. 2). Within the schematic cross-sectional diagram of FIG. 3, the foregoing series of layers is separated by a series patterned planarized intra coil dielectric layers 20a, 20b, 20c, 20d, 20e, 20f, 20g, 20h, 20i and 20j (representative of the patterned planarized intra coil dielectric layers 20 as illustrated within the schematic plan view diagram of FIG. 2).

As is illustrated within the schematic cross-sectional diagram of FIG. 3, the pair of annular magnetic shielding layers 18a and 18b, as well as the magnetic core layer 16, are formed of a thickness (typically and preferably from about 10000 to about 50000 angstroms) greater than the series of spirally patterned conductor layers 12a, 12b, 12c, 12d, 12e and 12f (which is typically and preferably from about 3000 to about 10000 angstroms). Such a thickness differential is, however, not required within the present invention. However, with respect to the magnetic core layer 16 there is provided enhanced performance of the microelectronic inductor structure whose schematic cross-sectional diagram is illustrated in FIG. 3 when the magnetic core layer 16 is formed of increased height in comparison with the series of spirally patterned conductor layers 12a, 12b, 12c, 12d, 12e and 12f. Similarly, with respect to the pair of annular magnetic shielding layers 18a and 18b, the pair of annular magnetic shielding layers 18a and 18b also provide enhanced magnetic shielding properties to the microelectronic inductor structure whose schematic cross-sectional diagram is illustrated in FIG. 3 when formed with enhanced height.

Within the preferred embodiment of the present invention with respect to the series of spirally patterned conductor layers 12a, 12b, 12c, 12d, 12e and 12f, the series of spirally patterned conductor layers 12a, 12b, 12c, 12d, 12e and 12f may be formed from any of several conductor materials as are conventional in the art of microelectronic fabrication for forming inductor structures within microelectronic fabrications, such conductor materials being selected from the group including but not limited to: (1) nonmagnetic metal and non-magnetic metal alloy (such as but not limited to aluminum, aluminum alloy, copper and copper alloy) conductor materials: (2) magnetic metal and magnetic metal alloy (such as permalloy and higher order alloys incorporating permalloy alloy) conductor materials; (3) doped polysilicon (having a dopant concentration greater than about 1E15 dopant atoms per cubic centimeter) and polycide (doped polysilicon/metal silicide stack) conductor materials; and (3) laminates thereof. Typically and preferably, each of the spirally patterned conductor layers 12a, 12b, 12c, 12d, 12e and 12f is formed at least in part of a nonmagnetic metal or metal alloy conductor material.

Similarly, within the preferred embodiment of the present invention, the magnetic core layer 16 and the pair of annular magnetic shielding layers 18a and 18b is typically and preferably formed of a ferromagnetic material, such as but not limited to a nickel cobalt alloy having a nickel content of from about 20 to about 60 weight percent and a cobalt content of from about 50 to about 70 weight percent ferromagnetic shielding material, formed to a thickness of from about 10000 to about 50000 angstroms. However, other ferromagnetic materials, such as but not limited to iron, cobalt, nickel ferromagnetic materials may also be employed for forming the magnetic core layer 16 and the pair of annular magnetic shielding layers 18a and 18b.

Upon forming the microelectronic fabrication whose schematic cross-sectional diagram is illustrated in FIG. 3, there is formed a microelectronic fabrication having formed therein a microelectronic inductor structure with enhanced performance. The microelectronic inductor structure exhibits enhanced performance insofar as there is formed annularly surrounding a planar spiral inductor within the microelectronic inductor structure an annular magnetic shielding layer.

As is understood by a person skilled in the art, the preferred embodiment of the present invention is illustrative of the present invention rather than limiting of the present invention. Revisions and modifications may be made to methods, materials, structures and dimensions through which is fabricated a microelectronic inductor structure in accord with the preferred embodiment of the present invention while still fabricating a microelectronic inductor structure in accord with the present invention, further in accord with the appended claims.

What is claimed is:

1. A method for fabricating an inductor structure comprising:
providing a substrate;
forming over the substrate a spirally patterned conductor layer which forms a planar spiral inductor; and
forming over the substrate such as to annularly surround the spirally patterned conductor layer an annular magnetic shielding layer.

2. The method of claim 1 wherein the spirally patterned conductor layer is formed to a thickness of from about 0.3 to about 10000 angstroms.

3. The method of claim 1 wherein the annular magnetic shielding layer is formed to a thickness of from about 10000 to about 50000 angstroms.

4. A method for fabricating an inductor structure comprising:
providing a substrate;
forming over the substrate a spirally patterned conductor layer which forms a planar spiral inductor; and
forming over the substrate such as to annularly surround the spirally patterned conductor layer an annular magnetic shielding layer formed of a ferromagnetic material.

5. The method of claim 4 wherein the spirally patterned conductor layer is formed to a thickness of from about 0.3 to about 10000 angstroms.

6. The method of claim 4 wherein the annular magnetic shielding layer is formed to a thickness of from about 10000 to about 50000 angstroms.

7. The method of claim 4 wherein the ferromagnetic material is selected from the group consisting of nickel cobalt alloys and iron, cobalt and nickel.

8. An inductor structure comprising:
a substrate;
a spirally patterned conductor layer formed over the substrate, where the spirally patterned conductor layer forms a planar spiral inductor; and
an annular magnetic shielding layer formed over the substrate and annularly surrounding the spirally patterned conductor layer.

9. The inductor structure of claim 8 wherein the spirally patterned conductor layer is formed to a thickness of from about 0.3 to about 10000 angstroms.

10. The inductor structure of claim 8 wherein the annular magnetic shielding layer is formed to a thickness of from about 10000 to about 50000 angstroms.

11. An inductor structure comprising:
a substrate;
a spirally patterned conductor layer formed over the substrate, where the spirally patterned conductor layer forms a planar spiral inductor; and
an annular magnetic shielding layer formed over the substrate and annularly surrounding the spirally patterned conductor layer, the annular magnetic shielding layer being formed of a ferromagnetic material.

12. The inductor structure of claim 11 wherein the spirally patterned conductor layer is formed to a thickness of from about 0.3 to about 10000 angstroms.

13. The inductor structure of claim 11 wherein the annular magnetic shielding layer is formed to a thickness of from about 10000 to about 50000 angstroms.

14. The inductor structure of claim 11 wherein the ferromagnetic material is selected from the group consisting of nickel cobalt alloys and iron, cobalt and nickel.
